(19) United States
(12) Patent Application Publication
(10) Pub. No.: US 2006/0272593 A1
(43) Pub. Date: Dec. 7, 2006

(54) Contour grooming rakes and methods thereof

(76) Inventor: Mark D. Morrison, Stamford, CT (US)

Correspondence Address: Todd A. Sullivan;HAYES SOLOWAY PC, 175 Canal Street, Manchester, NH, 03101, US

(21) Appl. No.: 11/141,923

(22) Filed: Jun. 1, 2005

(51) Int. Cl. A01K 13/00

(52) U.S. Cl. 119/632

(57) ABSTRACT

A grooming rake for animals includes a handle and a brush head with an arc shaped, side profile which is connected to the handle. The grooming rake provides an easier, faster, and more efficient grooming tool for animals.

### FIELD OF THE INVENTION

This invention generally relates to grooming tools and, more particularly, to contour grooming rakes for pets and methods thereof.

### BACKGROUND

One of the routine requirements of animal care is periodic grooming to remove loose fur and to stimulate new hair growth. Typically, this is accomplished with a brush or grooming rake 8 which has a substantially straight side profile as shown in FIG. 1. Unfortunately, one of the problems with these types of existing rakes is that they are flat so they only come in contact with the coat of an animal A in a limited area. As a result, the rake must be moved around the back and body of the animal A to get all the loose fur out and to smooth the fur.

### SUMMARY

A grooming rake for animals in accordance with embodiments of the present invention includes a handle and a brush head connected at one end to the handle. The brush head has a side profile which is arc shaped.

A method for making a grooming rake for animals in accordance with other embodiments of the present invention includes providing a handle and connecting a brush head to the handle. The brush head has a side profile which is arc shaped.

The present invention provides a grooming rake that makes grooming of animals, such as dogs, easier and faster. The grooming rake has an arc shaped side contour which is substantially the same as an animal's back. This enables the grooming rake to come in contact with much more of the animal's fur during a brush stroke at one time. As a result, grooming of the animal is much more efficient and faster.

### BRIEF DESCRIPTION OF THE DRAWINGS

FIG. 1 is a side view of a prior art grooming brush for animals;

FIG. 2 is a side view of a grooming rake in accordance with embodiments of the present invention; and

FIG. 3 is a top view of the grooming rake shown in FIG. 2.

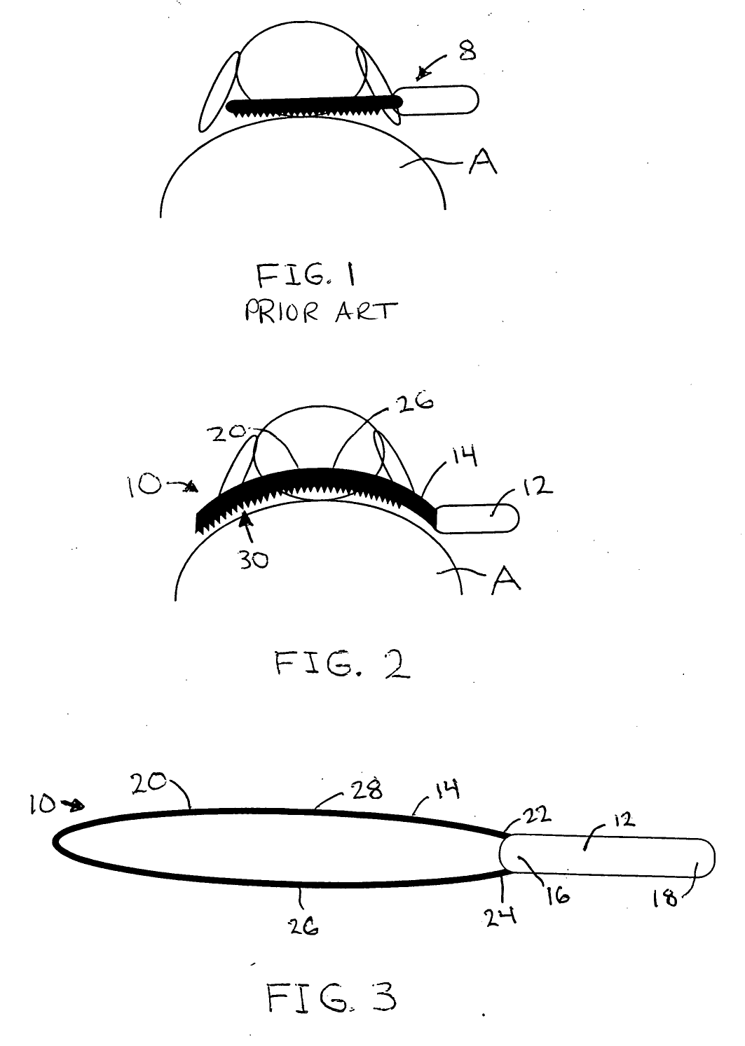

### DETAILED DESCRIPTION

A grooming rake 10 in accordance with embodiments of the present invention is illustrated in FIGS. 2 and 3. The grooming rake 10 includes a handle 12 and a brush head 14 with an arc shaped side profile connected to the handle 12, although the grooming rake 10 can comprise other numbers and types of components in other configurations and shapes. The present invention provides a grooming rake 10 that makes grooming of an animal A easier and faster.

Referring more specifically to FIGS. 2 and 3, the handle 12 is an elongated piece with a pair of opposing ends 16 and 18 and which is contoured to fit in a palm of a user's hand, although other types of handles and shapes for the handle 12 can be used. In this embodiment, the handle 12 is made from plastic, although other types of materials could be used.

The brush head 14 comprises an elongated, oval shaped section 20 with a pair of ends 22 and 24 which are connected to the one end 16 of the handle 12 and bristles 30, although the brush head 14 can have other numbers of sections in other shapes and configurations. The elongated, oval shaped section 20 has a pair of opposing, spaced apart portions 26 and 28, although the brush head 14 could have other numbers of spaced apart portions. The bristles 30 are connected to and extend out from the elongated, oval shaped section 20. In this particular embodiment, the elongated, oval shaped section 20 and the bristles 30 are made from plastic, although other types of materials could be used.

The elongated, oval shaped section 20 of the brush head 14 has a side profile which is arc shaped to substantially conform to the shape of an animal's back, such as the back of a dog. The arc shape for the brush head 14 helps to cover a larger surface area of the animal's fur during each brush stroke. Additionally, spaced apart portions 26 and 28 of the elongated, oval shaped section 20 of the brush head 14 help with the grooming of the animal by helping to dislodge and pick up loose fur and/or smooth fur that one portion 26 may have missed or only partially dislodged and/or smoothed with the other trailing one of the portions 28 during a brushing stroke.

A method for making and using a grooming rake 10 in accordance with embodiments of the present invention will now be described with reference to FIGS. 2 and 3. The bristles 30 are connected to the elongated, oval shaped section 20 of the brush head 14 and the bristles 30 extend out from the brush head 14 in the same general direction. The ends 22 and 24 of the elongated, oval shaped section 20 of the brush head 14 are connected to the one end 16 to the handle 12, although the brush head 14 and handle 12 can be constructed in other manners, such as with a one piece brush head 14 and handle 12.

To use the grooming rake 10, a user grasps the handle 12 and positions the arc shaped brush head 14 on to the animal's back and then begins a brush stroke. Since the brush head 14 substantially conform to the shape of an animal's back, the brush head 14 can cover a larger surface area of the animal's fur during the brush stroke. Additionally, with the spaced apart portions 26 and 28 of the brush head 14 any loose fur which was only partially dislodged and/or any fur which was not smoothed with the first portion 26 of the brush head 14 during a brushing stroke may be dislodged and/or smoothed with the trailing portion 28. As a result, the grooming rake 10 provides an easier, faster, and more efficient grooming tool for animals.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A grooming rake comprising:
a handle; and
a continuous brush head having two ends, wherein each end is connected to the handle, wherein the brush head has an arc shaped, side profile.

2. The rake as set forth in claim 1 further comprising bristles connected to and extending out from a concave side of the brush head.

3. The rake as set forth in claim 1 wherein the brush head further comprises an elongated and continuous section bent around in an oval shape with two opposing ends of the elongated and continuous section, connected to the handle.

4. (canceled)

5. (canceled)

6. A method for making a grooming rake, the method comprising:
providing a handle; and
connecting opposing ends of a continuous brush head to the handle, wherein the brush head has an arc shaped, side profile.

7. The method as set forth in claim 6 further comprising connecting bristles to a concave side of the brush head which extend out from the brush head.

8. The method as set forth in claim 6 wherein the brush head further comprises an elongated and continuous section bent around in an oval shape with two opposing ends of the elongated and continuous section, connected to the handle.

9. The method as set for the in claim 8 wherein the elongated section has at least two spaced apart portions.

10. (canceled)
